(19) United States
(12) Patent Application Publication
(10) Pub. No.: US 2024/0253706 A1
(43) Pub. Date: Aug. 1, 2024

(54) VEHICLE FRONT STRUCTURE

(71) Applicant: SUBARU CORPORATION, Tokyo (JP)

(72) Inventor: Isamu NAGASAWA, Tokyo (JP)

(21) Appl. No.: 18/535,807

(22) Filed: Dec. 11, 2023

(30) Foreign Application Priority Data
Jan. 30, 2023 (JP) 2023-012081

(51) Int. Cl. B62D 25/08

(52) U.S. Cl. CPC B62D 25/084

(57) ABSTRACT

A vehicle front structure includes front side frames in a pair extending in a vehicle front-rear direction respectively at both sides of a front part of a vehicle in a vehicle width direction; a radiator support that is disposed between the front side frames, rectangular-frame-shaped in front view, and coupled to the front side frames respectively at both sides thereof in the vehicle width direction; a cross member extending between the front side frames in the vehicle width direction and disposed closer to a rear end of the vehicle than the radiator support; an electrical device disposed closer to the rear end than the cross member; radiator-support reinforcements in a pair respectively coupling outer ends of the radiator support in the vehicle width direction to the cross member; and a support member provided on the cross member and supporting respective rear ends of the radiator-support reinforcements from below.

### CROSS-REFERENCE TO RELATED APPLICATIONS

The present application claims priority from Japanese Patent Application No. 2023-012081 filed on Jan. 30, 2023, the entire contents of which are hereby incorporated by reference.

### BACKGROUND

The disclosure relates to a vehicle front structure.

Japanese Patent No. 7014092 describes a vehicle front structure including a bumper reinforcement extending in a vehicle width direction and a pair of left and right front side members disposed closer to a rear end of a vehicle than the bumper reinforcement. Crash boxes are disposed between the bumper reinforcement and the front side members. A cross member extending in the vehicle width direction couples front ends of the pair of front side members to each other. A high-voltage component group (electrical devices) including a motor is disposed closer to the rear end of the vehicle than the cross member. The position of the high-voltage component group in a front-rear direction is set so that a framework structure that is closer to a front end of the vehicle than the high-voltage component group is deformed in a frontal collision of the vehicle. In an offset collision of the vehicle, the cross member serves as a strut to restrain bending of the front side members, so that the front side members undergo axial compressive deformation and absorb collision energy. Thus, the protection performance for the high-voltage component group in an offset collision can be improved.

### SUMMARY

An aspect of the disclosure provides a vehicle front structure. The vehicle front structure includes front side frames in a pair, a radiator support, a cross member, an electrical device, radiator-support reinforcements in a pair, and a support member. The front side frames extend in a vehicle front-rear direction at both sides of a front part of a vehicle in a vehicle width direction of the vehicle. The radiator support is disposed between the front side frames. The radiator support is rectangular-frame-shaped in front view, and is coupled to the front side frames respectively at both sides of the radiator support in the vehicle width direction. The cross member extends in the vehicle width direction and disposed closer to a rear end of the vehicle than the radiator support. The cross member extends between the front side frames. The electrical device is disposed closer to the rear end of the vehicle than the cross member. The radiator-support reinforcements respectively couple outer ends of the radiator support in the vehicle width direction to the cross member. The support member is provided on the cross member and supports respective rear ends of the pair of radiator-support reinforcements from below in an up-down direction of the vehicle.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is a schematic plan view of a front part of a vehicle including a vehicle front structure according to an embodiment viewed from above;

FIG. 2 is a sectional view of a central region, in a vehicle width direction, of the front part of the vehicle illustrated in FIG. 1 viewed from the left (sectional view taken along line II-II in FIG. 1);

FIG. 3A is an enlarged front view of a region including a rear end of a radiator-support reinforcement illustrated in FIG. 1 when viewed from the front;

FIG. 3B is a sectional view taken along line IIIB-IIIB in FIG. 3A;

FIG. 4 is a sectional view illustrating the manner in which the radiator-support reinforcement is fixed to a modification of a cross member illustrated in FIG. 3B when viewed from the left; and

FIG. 5 is a sectional view illustrating the manner in which the radiator-support reinforcement is fixed to another modification of the cross member illustrated in FIG. 3B when viewed from the left.

### DETAILED DESCRIPTION

The above-described vehicle front structure has room for improvement. In an offset collision of the vehicle, a colliding body often pushes down a front end part, such as a radiator support, of the vehicle and moves into the vehicle depending on, for example, a movement of the vehicle during the collision. In such a case, an effective reaction force cannot be applied to the colliding body, and there is a risk that the colliding body will move into a region in which the high-voltage component group (electrical devices) is disposed.

In addition, in an underride collision, which is a frontal collision of a vehicle in which the vehicle goes under the colliding body, the colliding body moves into an upper front region of the vehicle. In other words, the colliding body pushes down a front end part, such as the radiator support, of the vehicle and moves into the vehicle. Also in this case, an effective reaction force cannot be applied to the colliding body, and there is a risk that the colliding body will move into the region in which the high-voltage component group (electrical device) is disposed. Therefore, the above-described vehicle front structure has room for improvement in the protection performance for the high-voltage component group (electrical device).

It is desirable to provide a vehicle front structure with improved protection performance for an electrical device.

In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

A vehicle (automobile) V including a vehicle front structure S according to the embodiment will now be described with reference to the drawings. In the drawings, arrow FR indicates a forward direction with respect to the vehicle V, arrow UP indicates an upward direction with respect to the vehicle, and arrow LH indicates a leftward direction (one direction along a vehicle width direction) with respect to the vehicle when viewed from above the vehicle. In the following description, up-down, front-rear, and left-right directions are respectively up-down, front-rear, and left-right directions with respect to the vehicle unless specified otherwise.

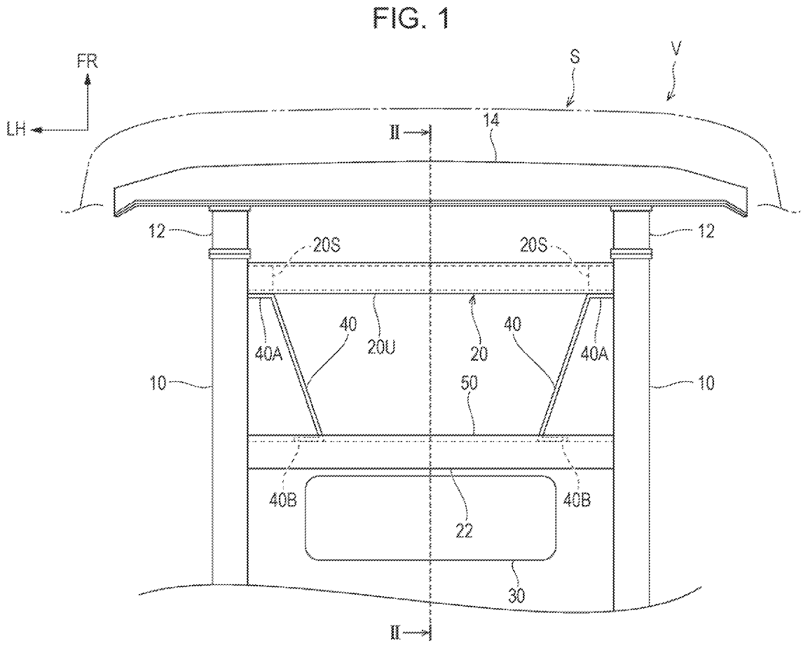

As illustrated in FIGS. 1 to 3B, the vehicle front structure S is applied to a front part of the vehicle V. The vehicle front structure S includes a pair of left and right front side frames 10, a bumper beam 14, a radiator support 20, and a cross member 22. The vehicle front structure S also includes a pair of left and right radiator-support reinforcements 40 and a pair of upper and lower support guides 50 provided on the cross member 22 and serving as support members. Components of the vehicle front structure S will now be described.

The pair of front side frames 10 have the shape of a hollow, substantially rectangular beam extending in the front-rear direction, and are disposed at both sides of the front part of the vehicle V in the vehicle width direction (left-right direction). Crash boxes 12 are provided in front of the front side frames 10. The crash boxes 12 have a substantially rectangular tubular shape with an axial direction coinciding with the front-rear direction. Rear ends of the crash boxes 12 are coupled to front ends of the front side frames 10.

The bumper beam 14 extends in the vehicle width direction and constitutes a framework at the front end of the vehicle V. The bumper beam 14 is substantially rectangular frame shaped in cross section when viewed in a longitudinal direction of the bumper beam 14. In other words, the bumper beam 14 is structured to have a closed rectangular cross section. The bumper beam 14 is coupled to front ends of the crash boxes 12 with both ends thereof in the vehicle width direction projecting outward from the front side frames 10 in the vehicle width direction. Thus, the bumper beam 14 is coupled to the front side frames 10 with the crash boxes 12 disposed between the bumper beam 14 and the front side frames 10. The crash boxes 12 may be omitted, and the bumper beam 14 may be directly coupled to the front ends of the front side frames 10.

The radiator support 20 is substantially rectangular frame shaped in front view as viewed from the front. The radiator support 20 includes a pair of left and right radiator side supports 20S; a radiator upper support 20U; and a radiator lower support 20L. The pair of left and right radiator side supports 20S extend in the up-down direction and define both sides of the radiator support 20 in the vehicle width direction. The radiator upper support 20U extends in the left-right direction and couples upper ends of the radiator side supports 20S to each other. The radiator lower support 20L extends in the left-right direction and couples lower ends of the radiator side supports 20S to each other. The radiator support 20 is disposed between the front ends of the pair of front side frames 10, and the radiator side supports 20S are joined to the front side frames 10 at positions near the lower ends thereof. In other words, the radiator support 20 projects upward from the front side frames 10. The radiator side supports 20S have the shape of a substantially hollow rectangular column extending in the up-down direction. A radiator (not illustrated) is disposed inside the radiator support 20, and is supported by the radiator support 20.

The cross member 22 has the shape of a hollow, substantially rectangular beam extending in the vehicle width direction. The cross member 22 is disposed behind and separated from the radiator support 20, and both ends of the cross member 22 in the left-right direction are fixed to inner walls of the front side frames 10 in the vehicle width direction. An inverter device 30, which serves as an electrical device, is provided behind the cross member 22. The inverter device 30 is supported by a frame member (not illustrated) coupled to the front side frames 10. As described in detail below, the positions of the cross member 22 and the inverter device 30 in the front-rear direction are set so that, in a frontal collision of the vehicle V, a region in front of the cross member 22 in a front part of the vehicle V collapses to prevent the colliding body from reaching the inverter device 30.

The left and right radiator-support reinforcements 40 are symmetrical to each other about the center of the vehicle V in the vehicle width direction. Therefore, the right radiator-support reinforcement 40 will be described below, and description of the left radiator-support reinforcement 40 will be omitted.

The radiator-support reinforcement 40 is disposed between the radiator support 20 and the cross member 22 and couples the corresponding radiator side support 20S to the cross member 22. The radiator-support reinforcement 40 has the shape of a substantially trapezoidal plate whose thickness direction is the left-right direction, and tilts toward the center in the vehicle width direction with increasing distance in the rearward direction in plan view. The length of the radiator-support reinforcement 40 in the up-down direction at the front end of the radiator-support reinforcement 40 is somewhat less than the length of the radiator side support 20S in the up-down direction. A front fixing flange 40A that is bent outward in the vehicle width direction is provided at the front end of the radiator-support reinforcement 40. The front fixing flange 40A is disposed adjacent to and behind the radiator side support 20S, and is fixed to the radiator side support 20S by, for example, welding. The upper end of the front fixing flange 40A is positioned behind the upper end of the radiator side support 20S, and the lower end of the front fixing flange 40A is disposed above the lower end of the radiator side support 20S and below the corresponding front side frame 10. The length of the front fixing flange 40A in the up-down direction may be substantially equal to that of the radiator side supports 20S, so that the lower end of the front fixing flange 40A is disposed behind the lower end of the radiator side support 20S.

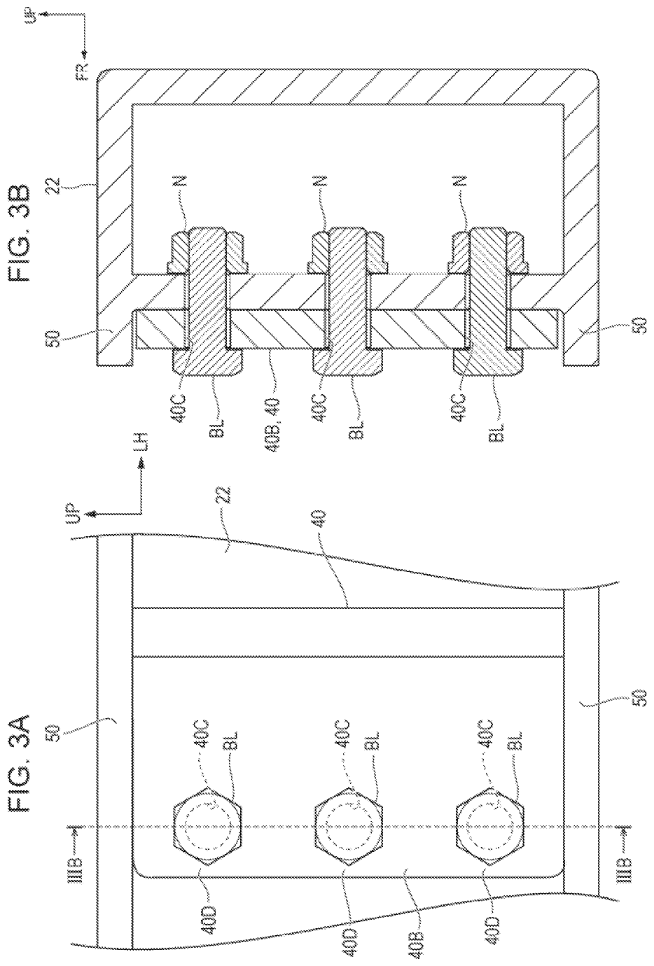

A rear fixing flange 40B that is bent outward in the vehicle width direction and serves as a coupler is formed at the rear end of the radiator-support reinforcement 40. The length of the rear fixing flange 40B in the up-down direction corresponds to a distance between the pair of upper and lower support guides 50 described below, and is less than the length of the front fixing flange 40A in the up-down direction. In other words, the rear fixing flange 40B is located below the upper end of the front fixing flange 40A. The rear fixing flange 40B has fixing holes 40C (three fixing holes in the present embodiment, see FIGS. 3A and 3B) extending therethrough. The fixing holes 40C are arranged with predetermined intervals therebetween in the up-down direction. Fixing bolts BL are inserted into the fixing holes 40C from the front, and screwed into fixing nuts N provided on a rear surface of a front wall of the cross member 22. Thus, the rear fixing flange 40B is fixed to the cross member 22. When the rear fixing flange 40B is fixed to the cross member 22, the rear fixing flange 40B extends in the up-down direction along the cross member 22 in a region excluding the upper and lower ends of the cross member 22.

A part of the rear fixing flange 40B disposed on the outer side of the fixing holes 40C in the vehicle width direction serves as a breakable part 40D. The breakable part 40D has a mechanical strength set so that the breakable part 40D breaks when the front end of the radiator-support reinforcement 40 receives a collision load greater than or equal to a predetermined load in a direction toward the rear end of the vehicle. For example, in a frontal collision of the vehicle V, the fixing bolts BL cause the breakable part 40D to break so that the rear fixing flange 40B is released from the cross member 22.

The pair of upper and lower support guides 50 are permanently affixed to the cross member 22. The support guides 50 have the shape of a rib that extends in the vehicle width direction, and project forward from the upper and lower ends of the front wall of the cross member 22. The pair of upper and lower support guides 50 are disposed adjacent to both ends of the rear fixing flange 40B of the radiator-support reinforcement 40 in the up-down direction, and support the rear fixing flange 40B from both sides in the up-down direction. An extension length of the support guides 50 is substantially equal to that of the cross member 22. In other words, the support guides 50 extend over the entire region of the cross member 22 in the longitudinal direction.

The operation and effects of the present embodiment will now be described.

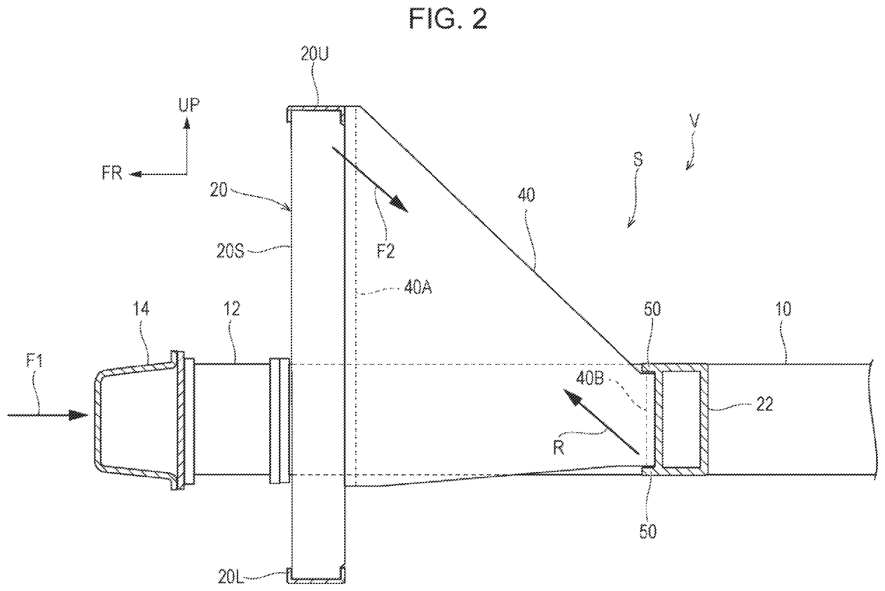

In a frontal collision of the vehicle V, the colliding body collides with the front end of the vehicle V over substantially the entire region in the vehicle width direction. Therefore, the bumper beam 14 receives a collision load (see arrow F1 in FIG. 2) in the direction toward the rear end of the vehicle over substantially the entire region in the longitudinal direction, and the crash boxes 12 undergo compressive deformation due to the collision load. Thus, the crash boxes 12 reduce the collision load. When the colliding body moves further rearward, the front ends of the front side frames 10 and the radiator support 20 receive the collision load. Since the radiator support 20 is supported from the rear by the radiator-support reinforcements 40, the front ends of the radiator-support reinforcements 40 receive the rearward collision load. Thus, the collision load is transmitted rearward along the radiator-support reinforcements 40, and is applied to the rear fixing flanges 40B at the rear ends of the radiator-support reinforcements 40.

The radiator-support reinforcements 40 tilt toward the center in the vehicle width direction with increasing distance in the rearward direction in plan view. Therefore, when the rear fixing flanges 40B receive the collision load transmitted along the radiator-support reinforcements 40, components of the collision load in the vehicle width direction cause the rear fixing flanges 40B to move relative to the cross member 22 toward the center in the vehicle width direction. The breakable part 40D of each rear fixing flange 40B has a mechanical strength set so that the breakable part 40D is caused to break by the fixing bolts BL in a frontal collision of the vehicle V. Therefore, the rear fixing flanges 40B are released from the cross member 22.

The rear fixing flanges 40B are supported from both sides in the up-down direction by the pair of upper and lower support guides 50. Therefore, when the rear fixing flanges 40B are released from the cross member 22, the rear fixing flanges 40B move toward the center in the vehicle width direction along the cross member 22 while being guided by the pair of upper and lower support guides 50. In other words, the radiator-support reinforcements 40 do not serve as struts, and are deformed so as to collapse. Therefore, the entirety of the radiator support 20 moves rearward, and the collision load is appropriately applied to the front side frames 10, so that the front side frames 10 undergo compressive deformation in the front-rear direction. Thus, in a frontal collision, the crash boxes 12 and the front side frames 10 undergo compressive deformation in the front-rear direction, thereby absorbing collision energy applied to the vehicle V. In a frontal collision, the crash boxes 12 and the front side frames 10 are deformed in a region in front of the cross member 22, so that the colliding body is restrained from reaching the inverter device 30. Thus, the collision energy absorption performance in a frontal collision can be maintained, and the inverter device 30 can be reliably protected.

In an offset collision of the vehicle V, the colliding body collides with the front end part of the vehicle V in an outer region in the vehicle width direction. Therefore, the bumper beam 14 receives the rearward collision load in the outer region in the vehicle width direction, and the corresponding crash box 12 undergoes compressive deformation in the front-rear direction. In the offset collision, for example, the colliding body often moves rearward into the region above the front side frames 10 depending on a movement, for example, pitching, of the vehicle V at the time of collision. In more detail, the colliding body moves inward so as to push down the radiator side support 20S rearward in the outer region of the radiator support 20 in the vehicle width direction. Thus, the radiator side support 20S is deformed so as to tilt rearward.

When the radiator side support 20S is deformed so as tilt rearward, the radiator-support reinforcement 40 that supports the radiator side support 20S from the rear also tilts downward. Namely, the rearward and downward collision load (see arrow F2 in FIG. 2) is mainly applied to the front end of the radiator-support reinforcement 40. The rear fixing flange 40B provided at the rear end of the radiator-support reinforcement 40 is supported by the support guides 50 of the cross member 22 from both sides in the up-down direction. In other words, the rear fixing flange 40B is supported by the support guides 50 at least from below. Therefore, the radiator-support reinforcement 40 receives a forward and upward reaction force (see arrow R in FIG. 2) from the support guides 50 and the cross member 22. Thus, also when the colliding body moves inward so as to push down the upper part of the radiator support 20 rearward in the outer region in the vehicle width direction, the support guides 50 serve as a reaction-force-applying member that applies a reaction force to the colliding body so that the colliding body receives an effective reaction force. As a result, the colliding body is restrained from moving into the front part of the vehicle V in an offset collision, and the risk of damage to the inverter device 30 can be reduced. Thus, the protection performance for the inverter device 30 in an offset collision can be improved.

In an underride collision of the vehicle V, the vehicle V goes under the colliding body. Therefore, the colliding body moves rearward into the front part of the vehicle V in a region above the bumper beam 14. For example, the colliding body collides with an upper part of the radiator support 20 and pushes the upper part of the radiator support rearward. The lower ends of the radiator side supports 20S of the radiator support 20 are coupled to the front side frames 10. Therefore, the radiator support 20 is deformed so as to tilt rearward. Accordingly, similarly to the offset collision described above, the radiator-support reinforcements 40 that support the radiator side supports 20S from the rear also tilt rearward. Thus, the rearward and downward collision load is applied to the front ends of the radiator-support reinforcements 40.

In addition, as described above, the rear fixing flanges 40B provided at the rear ends of the radiator-support reinforcements 40 are supported by the support guides 50 of the cross member 22 from both sides in the up-down direction. Therefore, the radiator-support reinforcements 40 receive a forward and upward reaction force from the support guides 50 and the cross member 22. Thus, also when the colliding body moves inward so as to push down the upper part of the radiator support 20 rearward, the support guides 50 serve as a reaction-force-applying member that applies a reaction force to the colliding body so that the colliding body receives an effective reaction force. As a result, the colliding body is restrained from moving into the front part of the vehicle V in an underride collision, and the risk of damage to the inverter device 30 can be reduced. Thus, the protection performance for the inverter device 30 in an underride collision can also be improved.

As described above, in the vehicle front structure S according to the present embodiment, the cross member 22 is disposed in front of the inverter device 30 and behind the radiator support 20, and extends between the pair of left and right front side frames 10. The radiator-support reinforcements 40 couple the radiator side supports 20S of the radiator support 20 to the cross member 22, and the rear fixing flanges 40B of the radiator-support reinforcements 40 are supported by the pair of upper and lower support guides 50 of the cross member 22 from both sides in the up-down direction. Accordingly, as described above, in an offset collision or an underride collision of the vehicle V, the radiator support 20 that tilts rearward can receive a forward and upward reaction force from the support guides 50 and the cross member 22 through the radiator-support reinforcements 40. As a result, in these collisions, an effective reaction force can be applied to the colliding body, and the colliding body can be restrained from moving rearward into the front part of the vehicle V. Therefore, the protection performance for the inverter device 30 mounted in the front part of the vehicle V can be improved.

In a frontal collision of the vehicle V, as described above, the front ends of the radiator-support reinforcements 40 receive the rearward collision load, and the rear fixing flanges 40B of the radiator-support reinforcements 40 are released from the cross member 22. Therefore, in a frontal collision of the vehicle V, the function of the radiator-support reinforcements 40 is canceled and the collision load in the frontal collision can be appropriately transmitted to the front side frames 10. In other words, in a frontal collision, the front part of the vehicle V has a sufficient crash stroke, and the collision energy can be appropriately absorbed. Therefore, even though the radiator-support reinforcements 40 that support the radiator support 20 from the rear are provided, the collision resistance performance in a frontal collision can be maintained, and the protection performance for the inverter device 30 can be improved.

The pair of left and right radiator-support reinforcements 40 tilt toward the center in the vehicle width direction with increasing distance in the rearward direction in plan view. Therefore, in a frontal collision, the radiator-support reinforcements 40 can be restrained from serving as struts, and the rear ends of the radiator-support reinforcements 40 can receive a collision load toward the center in the vehicle width direction. Thus, each rear fixing flange 40B can receive a load toward the center in the vehicle width direction, so that the fixing bolts BL can cause the breakable part 40D to break. Therefore, the collision resistance performance in a frontal collision can be effectively maintained.

The cross member 22 includes the pair of upper and lower support guides 50. The pair of support guides 50 extend in the vehicle width direction, and support the rear fixing flanges 40B of the radiator-support reinforcements 40 from both sides in the up-down direction. Therefore, after the rear fixing flanges 40B are released from the cross member 22 in a frontal collision, the rear fixing flanges 40B can move toward the center in the vehicle width direction along the cross member 22 while being guided by the pair of support guides 50. In other words, the radiator-support reinforcements 40 can be deformed so as to collapse by using, as the guides, the support guides 50 that apply the reaction force to the colliding body in an offset collision or an underride collision. Since the support guides 50 are permanently affixed to the cross member 22, the number of components and the costs can be reduced compared to when the support guides 50 and the cross member 22 are separate components.

The rear fixing flange 40B of each radiator-support reinforcement 40 is bent outward in the vehicle width direction, and is fixed to the cross member 22 with the fixing bolts BL. Therefore, in a frontal collision, the fixing bolts BL can cause the breakable part 40D to break appropriately. Thus, the radiator-support reinforcements 40 can be easily released from the cross member 22 by using a simple structure in a frontal collision.

The pair of upper and lower support guides 50 may be provided on the cross member 22 to move the rear fixing flange 40B toward the center in the vehicle width direction along the support guides 50 in a frontal collision. However, the upper support guide 50 on the cross member 22 may be omitted. Also in this case, the lower support guide 50 can apply the reaction force to the colliding body in an offset collision and an underride collision, and can guide the rear fixing flange 40B toward the center in the vehicle width direction in the frontal collision.

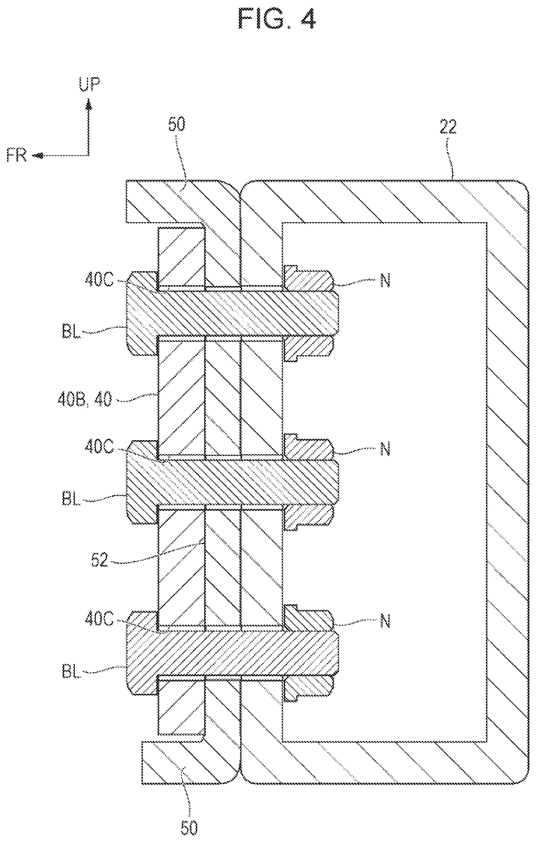

In the present embodiment, the support guides 50 are permanently affixed to the cross member 22. However, the support guides 50 may be separate from the cross member 22 and fixed to the cross member 22. For example, as illustrated in FIG. 4, a guide member 52 that extends in the left-right direction may be provided in front of the cross member 22, and the support guides 50 may be formed on the guide member 52. In more detail, the guide member 52 is a plate that is substantially U-shaped and opens toward the front when viewed in the left-right direction, and the upper and lower ends of the guide member 52 serve as the support guides 50. The guide member 52 is fixed to the cross member 22 by, for example, welding.

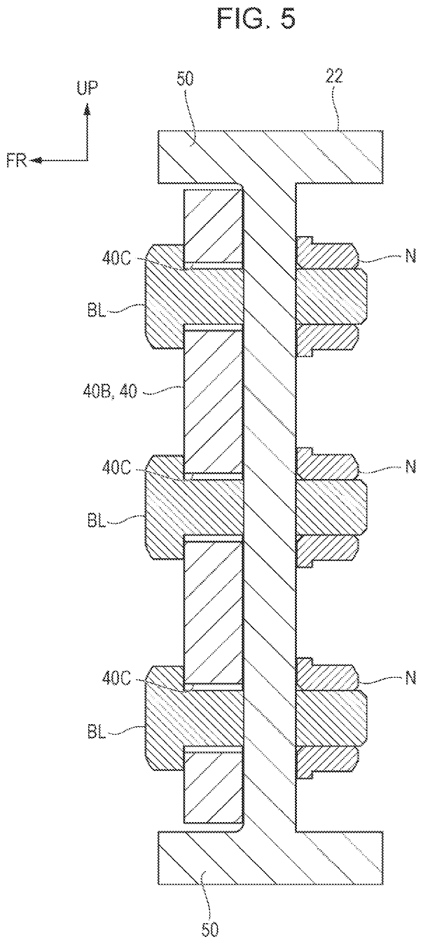

In the present embodiment, the cross member 22 has a closed rectangular shape in cross section. However, the cross-sectional shape of the cross member 22 may be changed to any shape. For example, as illustrated in FIG. 5, the cross member 22 may have an I-shaped cross section, and parts of the cross member 22 that project forward from the upper and lower ends may serve as the support guides 50.

In the present embodiment, the radiator-support reinforcements 40 are substantially trapezoidal-plate-shaped. However, the shape of the radiator-support reinforcements 40 is not limited to this. For example, each radiator-support reinforcement 40 may be composed of frame members arranged in a trapezoidal frame shape. In this case, the frame members may form a closed cross-sectional structure. The plate-shaped radiator-support reinforcements 40 according to the present embodiment may be provided with additional reinforcement beads or flanges as appropriate so that the radiator-support reinforcements 40 have a rigidity corresponding to various collision modes.

In the present embodiment, the breakable part 40D of the rear fixing flange 40B of each radiator-support reinforcement 40 breaks to release the radiator-support reinforcement 40 from the cross member 22 in a frontal collision. However, the method for releasing each radiator-support reinforcement 40 from the cross member 22 is not limited to this. For example, the rear fixing flange 40B may be fixed to the cross member 22 with a pin, and the pin may break to release the radiator-support reinforcement 40 from the cross member 22 when a frontal collision occurs.

According to one or more embodiments of the disclosure, the protection performance for an electrical device can be improved.

1. A vehicle front structure comprising:
front side frames in a pair, the front side frames extending in a vehicle front-rear direction respectively at both sides of a front part of a vehicle in a vehicle width direction of the vehicle;
a radiator support disposed between the front side frames, the radiator support being rectangular-frame-shaped in a front view of the vehicle and being coupled to the front side frames respectively at both sides of the radiator support in the vehicle width direction;
a cross member extending in the vehicle width direction and disposed closer to a rear end of the vehicle than the radiator support, the cross member extending between the front side frames;
an electrical device disposed closer to the rear end of the vehicle than the cross member;
a radiator-support reinforcements in a pair, the radiator-support reinforcements respectively coupling outer ends of the radiator support in the vehicle width direction to the cross member; and
a support member provided on the cross member and supporting respective rear ends of the radiator-support reinforcements from below in an up-down direction of the vehicle.

2. The vehicle front structure according to claim 1, wherein when the radiator-support reinforcements receive a collision load greater than or equal to a predetermined load in a direction toward the rear end of the vehicle, the respective rear ends of the radiator-support reinforcements are decoupled from the cross member.

3. The vehicle front structure according to claim 2, wherein the radiator-support reinforcements tilt toward a center in the vehicle width direction with increasing distance toward the rear end of the vehicle in a plan view of the vehicle.

4. The vehicle front structure according to claim 3, wherein
the cross member is provided with support members in a pair, the support members including the support member, and
the support members extend in the vehicle width direction and support the respective rear ends of the radiator-support reinforcements from both sides in the vehicle up-down direction.

5. The vehicle front structure according to claim 3, wherein
couplers are provided respectively at the respective rear ends of the radiator-support reinforcements, the couplers being bent outward in the vehicle width direction, and
wherein the couplers are fixed to the cross member.
